(19) United States
(12) Patent Application Publication
(10) Pub. No.: US 2012/0233313 A1
(43) Pub. Date: Sep. 13, 2012

(54) SHARED SCALING SERVER SYSTEM

(76) Inventors: Hironobu Fukami, Tokyo (JP); Kei Kubo, San Jose, CA (US)

(21) Appl. No.: 13/045,586

(22) Filed: Mar. 11, 2011

(51) Int. Cl. G06F 15/173

(52) U.S. Cl. 709/224

(57) ABSTRACT

The shared scaling server system of the present invention comprises a plurality of client terminals for transmitting a request, an application load balancer for distributing the request transmitted by the plurality of client terminals, a plurality of application servers for processing the request distributed by the application load balancer, a main server connected to the application load balancer and the plurality of application servers and having a monitor and a controller. The monitor monitors load status of the plurality of application servers, the monitor detects a site, in which access to a resource of at least one application server is increased when the monitor judges that load status of the at least one application server exceeds a threshold, the monitor checks availability of a resource of the plurality of application servers, the monitor transmits information about the availability of the resource of the plurality of application servers to the controller. The controller, depending on the information, processes traffic of the site, in which access is increased, in an available resource of the plurality of application servers and the controller, depending on the information, activates a new application server when there is no available resource in the plurality of application servers, allocates a firm comprising the site, in which access is increased, to an available resource of the new application server and processes traffic of the site, in which access is increased, in an available resource of the new application server.

### BACKGROUND OF THE INVENTION

1. Field of the Invention

The present invention relates to a shared scaling server system.

2. Description of the Related Art

Scalability is the ability of a computer system to flexibly improve performance and function in accordance with growth of users and load of the system. In recent years, an auto scaling function has been provided, which automatically allocates a necessary resource in accordance with load of a server in a system utilizing cloud computing such as Amazon Elastic Compute Cloud (EC2).

With reference to FIG. 1, scaling in a conventional system will be described.

When traffic of sites A, B and C is input as shown in FIG. 1(a), it is distributed to traffic of sites A, B and C through an application load balancer lb and firms (source groups uploaded by users) A, B and C comprising the sites A, B and C are respectively allocated to available resources of application servers app1 to app3 as shown in FIG. 1(b).

Next, when access to the site A is increased as shown in FIG. 1(c), traffic of the site A is processed in available resources of the application server app1, in which the firm A has been allocated, as shown in FIG. 1(d). When there is no available resource in the application server app1, an application server app4 is newly activated, the firm A is allocated to available resources of the application server app4 and traffic of the site A is processed in the available resources of the application server app4.

Subsequently, when access to the site C is increased as shown in FIG. 1(e), traffic of the site C is processed in available resources of the application server app3, in which the firm C has been allocated, as shown in FIG. 1(f). When there is no available resource in the application server app3, an application server app5 is newly activated, the firm C is allocated to available resources of the application server app5 and traffic of the site C is processed in the available resources of the application server app5.

In this way, traffic of a site is processed in an application server, in which a firm comprising a site has been allocated, or, when there is no available resource in this application server, the firm comprising the site is allocated to a new application server, where the traffic of the site is processed so that available resources exist in a plurality of application servers app2, app4 and app5.

In addition, when access to the site A is decreased from a state of FIG. 1(f), the firm A (3 blocks in this example) is released from the resource of the application server app4 as shown in FIG. 1 (g). However, the application server app4 keeps working unless all of the firm A of the application server app4 is released. Therefore, a plurality of application servers having available resources keep working so that application servers cannot be effectively used.

As described above, conventionally, when access to a certain site of an application server is increased, a resource has to be secured in the application server, in which a firm comprising the site has been allocated, or, if there is no available resource in the application server, an application server has to be newly activated without utilizing existing application servers. Therefore, application servers cannot be effectively used especially when the number of users is increased and the number of application servers is increased, whereby the number of available resources of the application servers is increased. When the number of application servers is increased, a cost of system use is also increased. Accordingly, a method of effectively using application servers is desired.

### SUMMARY OF THE INVENTION

It is an object of the present invention to solve the above-mentioned problems and to provide an effectively scalable server system using minimum necessary application servers.

The subject matters of the present invention are as follows.

(1) A shared scaling server system comprising:

a plurality of client terminals for transmitting a request;

an application load balancer for distributing the request transmitted by the plurality of client terminals;

a plurality of application servers for processing the request distributed by the application load balancer;

a main server connected to the application load balancer and the plurality of application servers and having a monitor and a controller;

wherein

the monitor monitors load status of the plurality of application servers;

the monitor detects a site, in which access to a resource of at least one application server is increased when the monitor judges that load status of the at least one application server exceeds a threshold;

the monitor checks availability of a resource of the plurality of application servers;

the monitor transmits information about the availability of the resource of the plurality of application servers to the controller;

the controller, depending on the information, processes traffic of the site, in which access is increased, in an available resource of the plurality of application servers; and

the controller, depending on the information, activates a new application server when there is no available resource in the plurality of application servers, allocates a firm comprising the site, in which access is increased, to an available resource of the new application server and processes traffic of the site, in which access is increased, in an available resource of the new application server.

(2) The shared scaling server system according to above (1), wherein

the monitor monitors load status of the plurality of application servers;

the monitor detects a site, in which access to a resource of at least one application server (a first application server) is decreased when the monitor judges that load status of the first application server is less than a threshold;

the monitor checks availability of a resource of the plurality of application servers; and

the monitor transmits information about the availability of the resource of the plurality of application servers to the controller; and

the controller, depending on the information, reallocates a firm allocated to a resource of an application server (a second application server) which has the smallest number of occupied resources, to an available resource of an application server except the second application server and stops the second application server when the number of occupied resources of the second application server becomes 0, or

the controller, depending on the information, reallocates a firm allocated to a resource of the first application server to an available resource of an application server except the first application server and stops the first application server when the number of occupied resources of the first application server becomes 0.

(3) The shared scaling server system according to above (1) or (2) further comprising

a database load balancer for distributing data transmitted by the plurality of application servers and

a plurality of database servers for storing the data distributed by the database load balancer,

wherein

the database load balancer and the plurality of database servers are connected to the main server;

the monitor monitors load status of the plurality of database servers;

the monitor detects a site, in which access to a resource of at least one database server is increased when the monitor judges that load status of the at least one database server exceeds a threshold;

the monitor checks availability of a resource of the plurality of database servers;

the monitor transmits information about the availability of the resource of the plurality of database servers to the controller;

the controller, depending on the information, processes traffic of the site, in which access is increased, in an available resource of the plurality of database servers; and

the controller, depending on the information, activates a new database server when there is no available resource in the plurality of database servers, allocates a firm comprising the site, in which access is increased, to an available resource of the new database server and processes traffic of the site, in which access is increased, in an available resource of the new database server.

(4) The shared scaling server system according to above (3), wherein

the monitor monitors load status of the plurality of database servers;

the monitor detects a site, in which access to a resource of at least one database server (a first database server) is decreased when the monitor judges that load status of the first database server is less than a threshold;

the monitor checks availability of a resource of the plurality of database servers; and

the monitor transmits information about the availability of the resource of the plurality of database servers to the controller; and

the controller, depending on the information, reallocates a firm allocated to a resource of an database server (a second database server) which has the smallest number of occupied resources, to an available resource of an database server except the second database server and stops the second database server when the number of occupied resources of the second database server becomes 0, or

the controller, depending on the information, reallocates a firm allocated to a resource of the first database server to an available resource of an database server except the first database server and stops the first database server when the number of occupied resources of the first database server becomes 0.

### BRIEF DESCRIPTION OF THE DRAWINGS

FIG. 1 is a schematic diagram showing scaling in a conventional system.

FIG. 2 is a block diagram of a shared scaling server system according to the first embodiment of the present invention.

FIG. 3 is a block diagram of an application load balancer of the shared scaling server system according to the first embodiment of the present invention.

FIG. 4 is a block diagram of an application server of the shared scaling server system according to the first embodiment of the present invention.

FIG. 5 is a schematic diagram showing one aspect that a firm is allocated to a resource when access is increased in the shared scaling server system according to the first embodiment of the present invention.

FIG. 6 is a flow chart showing processes of a main server in the aspect of FIG. 5.

FIG. 7 is a schematic diagram showing one aspect that a firm is reallocated to a resource when access is decreased in the shared scaling server system according to the first embodiment of the present invention.

FIG. 8 is a flow chart showing processes of a main server in the aspect of FIG. 7.

FIG. 9 is a schematic diagram showing one aspect that a firm is reallocated to a resource when access is decreased in the shared scaling server system according to the first embodiment of the present invention.

FIG. 10 is a schematic diagram showing one aspect that a firm is reallocated to a resource when access is decreased in the shared scaling server system according to the first embodiment of the present invention.

FIG. 11 is a schematic diagram showing one aspect that a firm is reallocated to a resource when access is decreased in the shared scaling server system according to the first embodiment of the present invention.

FIG. 12 is a block diagram of a shared scaling server system according to the second embodiment of the present invention.

FIG. 13 is a block diagram of a database load balancer of the shared scaling server system according to the second embodiment of the present invention.

FIG. 14 is a block diagram of a database server of the shared scaling server system according to the second embodiment of the present invention.

### DETAILED DESCRIPTION

Hereinafter, a shared scaling server system of the present invention will be described in detail with reference to the drawings.

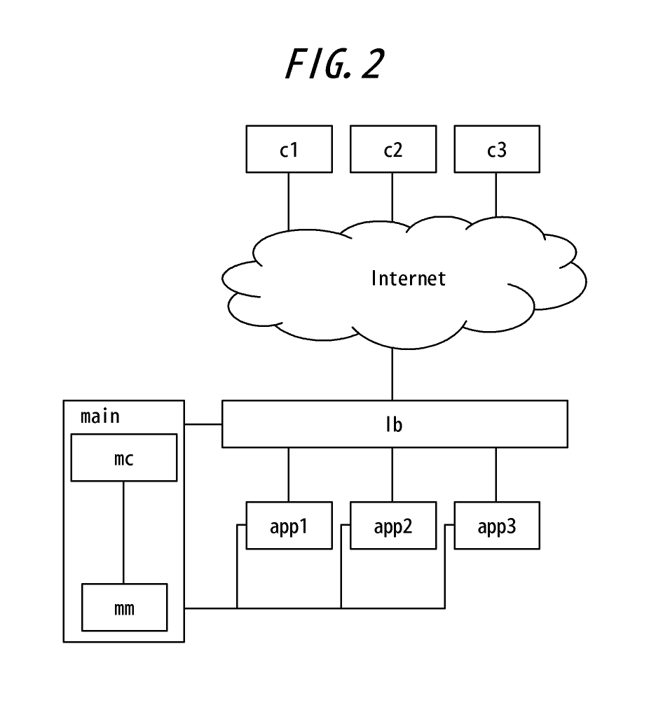

FIG. 2 is a block diagram of a shared scaling server system according to the first embodiment of the present invention.

The shared scaling server system according to the first embodiment of the present invention comprises a plurality of client terminals c1 to c3, an application load balancer lb, a plurality of application servers app1 to app3 and a main server main. It is noted that, although three client terminals c1 to c3 and three application servers app1 to app3 are shown in the first embodiment, two or more client terminals and two or more application servers may be used.

The client terminals c1 to c3 are personal computers connected to the Internet. The client terminals c1 to c3 are connected to the application load balancer lb through the Internet and transmit a request to the application servers app1 to app3 through the application load balancer lb.

The application load balancer lb is connected to the plurality of application servers app1 to app3. The application load balancer lb has a general load balancing function to distribute a request from the client terminals c1 to c3 to any of the application servers app1 to app3.

The application servers app1 to app3 perform processing depended on a request transmitted by the client terminals c1 to c3. The application servers app1 to app3 are set scalable and preferably exist on cloud computing.

The main server main has a monitor mm and a controller mc.

The monitor mm monitors load status (CPU utilization) and availability of resources of the plurality of application servers app1 to app3. It is noted that “monitoring availability of a resource” includes monitoring occupied status of the resource. The monitor mm transmits information about load status and availability of resources of the plurality of application servers app1 to app3 to the controller mc.

The controller mc activates a new application server app4 (not shown) depending on the information from the monitor mm and transmits instructions to the application load balancer lb in order to set the application server app4 to a distribution object. In addition, the controller mc stops any of the existing application servers app1 to app3 depending on the information from the monitor mm and transmits instructions to the application load balancer lb in order to release the stopped application server from the distribution object. In addition, the controller mc integrally controls operation of all portions of the main server main.

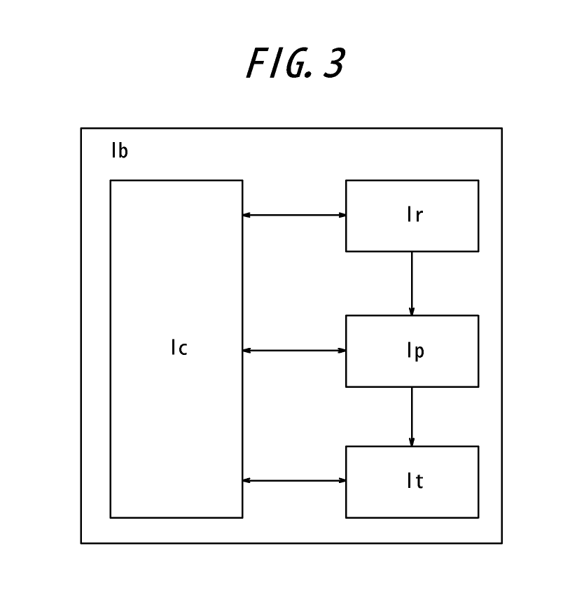

With reference to FIG. 3, the application load balancer lb will be described in more detail.

The application load balancer lb includes a receiver lr, a controller lc, a load balancing processor lp and a transmitter lt.

The receiver lr receives a packet transmitted through a network.

The controller lc transmits information of an application server of a distribution object to the load balancing processor lp depending on information from the main server main. For example, the controller lc transmits information that three application servers app1 to app3 are distribution objects to the load balancing processor lp. In addition, the controller lc integrally controls operation of all portions of the application load balancer lb.

The load balancing processor lp can employ well-known load balancing processing to perform load balancing processing. The load balancing processor lp receives a packet through the receiver lr and selects the most suitable application server according to well-known load distribution algorithm pre-set in the load balancing processor lp based on information from the controller lc.

The transmitter lt transmits a packet to the application servers app1 to app3 based on the selection of the load balancing processor lp.

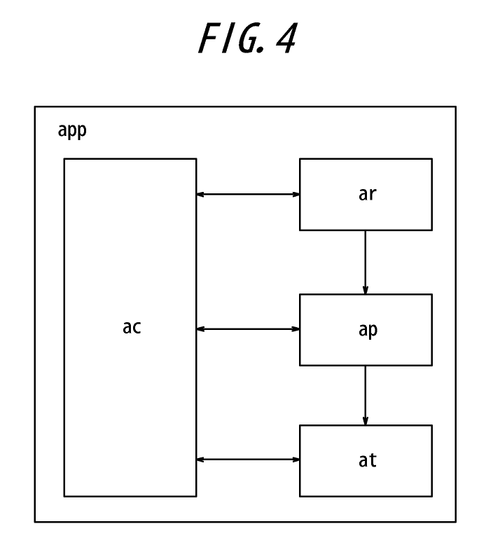

With reference to FIG. 4, the application server app will be described in more detail.

The application server app includes a receiver ar, a processor ap, a controller ac and a transmitter at.

The receiver ar receives a packet transmitted by the transmitter lt of the application load balancer lb.

The processor ap performs processing depending on a request transmitted by the client terminals c1 to c3. The processor ap comprises a CPU, for example.

The controller ac transmits information about load status of the processor ap and information about availability of resources to the main server main. In addition, the controller ac integrally controls operation of an portions of the application server app.

The transmitter at transmits a packet to the receiver lr of the application load balancer lb.

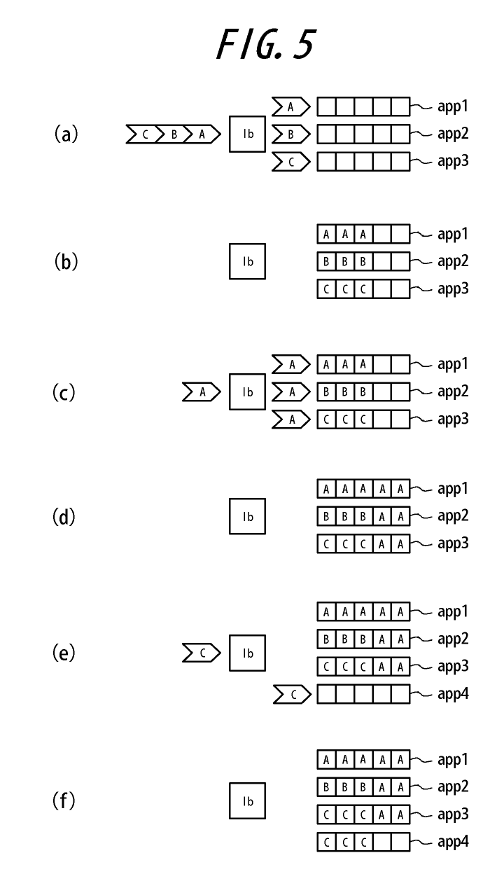

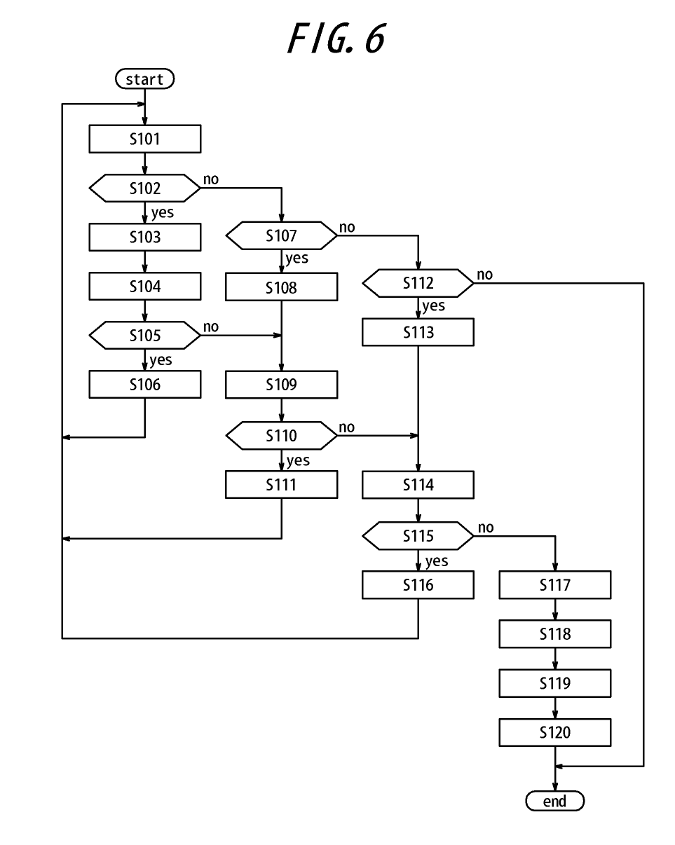

With reference to FIG. 5 and FIG. 6, processes of the main server when access is increased in the shared scaling server system according to the first embodiment of the present invention will be described. FIG. 5 shows one aspect that when access to a site is increased, a firm comprising the site is allocated to a resource and FIG. 6 is a flow chart showing processes of the main server.

When traffic of sites A, B and C is input as shown in FIG. 5(a), it is distributed to traffic of sites A, B and C through the application load balancer lb and firms A, B and C comprising the sites A, B and C are respectively allocated to available resources of the application servers app1 to app3 as shown in FIG. 5(b).

Next, when access to the site A is increased as shown in FIG. 5(c), traffic of the site A is divided into three pieces of traffic of the site A through the application load balancer lb and thus-distributed traffic of the site A is respectively processed in available resources of the application server app1 to app3 as shown in FIG. 5(d).

A flow of the above-mentioned processes will be described with reference to FIG. 6.

In step S101 the monitor mm of the main server main monitors load status of the processor ap of the application servers app1 to app3.

In step S102 if load status of the processor ap of the application server app1 exceeds a threshold (yes), in step S103 the monitor mm detects a site accessing the resource of the application server app1. In this example the monitor mm detect site A accessing the resource of the application server app1.

In step S104 the monitor mm checks whether the application server app1 includes an available resource.

In step S105 if the application server app1 includes an available resource (yes), in step S106 the controller mc processes traffic of a site in the available resource of the application server app1 and returns the process to step S101.

In this example, since the application server app1 includes available resources (2 blocks), the controller mc processes traffic of site A in the available resources of the application server app1.

In step S105 since the application server app1 has no available resource (no), the controller mc proceeds with the process to step S109.

In step S109 the monitor mm checks whether the application server app2 includes an available resource.

In step S110 if the application server app2 includes an available resource (yes), in step S111 the controller mc processes traffic of a site in the available resource of the application server app2 and returns the process to step S101.

In this example, since the application server app2 includes available resources (2 blocks), the controller mc processes traffic of site A in the available resources of the application server app2.

In step S110, since the application server app2 has no available resource (no), the controller mc proceeds with the process to step S114.

In step S114 the monitor mm checks whether the application server app3 includes an available resource.

In step S115 if the application server app3 includes an available resource (yes), in step S116 the controller mc processes traffic of a site in the available resource of the application server app3 and returns the process to step S101.

In this example, since the application server app3 includes available resources (2 blocks), the controller mc processes traffic of site A in the available resources of the application server app3. Since all traffic of site A is processed in the available resources of the application servers app1 to app3, the controller mc finishes the process. Specifically, in step S101 the monitor mm monitors load status of the processor ap of the application servers app1 to app3, in step S102 the monitor mm judges that load status of the processor ap of the application server app1 is not more than the threshold (no), in step S107 the monitor mm judges that load status of the processor ap of the application server app2 is not more than the threshold (no), in step S112 the monitor mm judges that load status of the processor ap of the application server app3 is not more than the threshold (no) and the controller mc finishes the process.

Subsequently, when access to the site C is increased as shown in FIG. 5(e), since there is no available resource in the application servers app1 to app3, an application server app4 is newly activated. Then the firm C comprising the site C is allocated to available resources of the application server app4 and traffic of the site C is processed in the available resources of the application server app4 as shown in FIG. 5(f).

A flow of the above-mentioned processes will be described with reference to FIG. 6.

In step S101 the monitor mm of the main server main monitors load status of the processor ap of each of the application servers app1 to app3. In this example, since access to site C is increased, in step S102 the monitor mm judges that load status of the processor ap of the application server app1 is not more than the threshold (no), in step S107 the monitor mm judges that load status of the processor ap of the application server app2 is not more than the threshold (no), and the controller mc proceeds with the process to step S112.

In step S112 the monitor mm judges that load status of the processor ap of the application server app3 exceeds the threshold (yes), in step S113 the monitor mm detects site C accessing the resource of the application server app3.

In step S114 the monitor mm checks whether the application server app3 includes an available resource.

In step S115 since there is no available resource in the application server app3 (no), in step S117 the controller mc activates new application server app4. It is assumed in this example that the number of available resources in the application servers app1, app2 and app3 is increased in this order according to reallocation of firms described below. In other words, if there is no available resource in the application server app3, it means that there is no available resource in the application servers app1 and app2, either.

In step S118 the controller mc allocates firm C comprising site C to available resources of the application server app4 and processes traffic of the site C in the available resources of the application server app4.

In step S119 the controller mc updates management information to show which firm is allocated to which application server. In this example the management information includes information that the resource of the application server app1 is assigned to firm A, the resource of the application server app2 is assigned to firms A and B, the resource of the application server app3 is assigned to firms A and C and the resource of the application server app4 is assigned to firm C.

In step S120 the controller mc sets the application server app4, in which firm C is newly allocated, to a distribution object.

Although a case where access to the sites A, C is increased in the existing application servers app1, app3 is described in this example, a case where access to the site B is increased in the existing application server app2 is similar. For example, in step S107 if load status of the processor ap of the application server app2 exceeds the threshold (yes), in step S108 the monitor mm detects a site accessing the resource of the application server app2.

Although it is assumed in this example that the number of available resources in the application servers app 1, app2 and app3 is increased in this order, the aspect of firm allocation is not limited to this example but can be flexibly set by the controller mc.

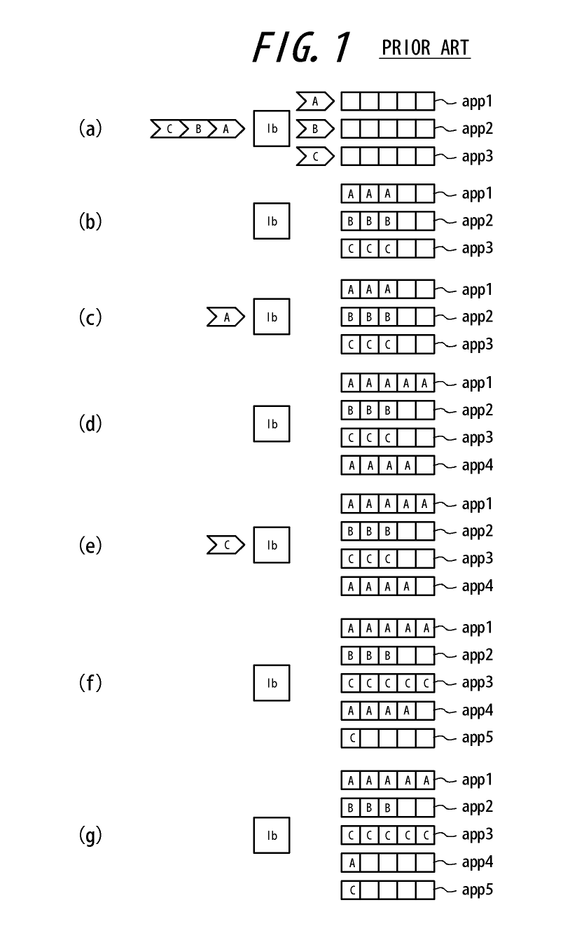

As described above, according to the present invention, even when the same traffic as that in the conventional example shown in FIG. 1 is input, a plurality of firms which are not related to each other can be allocated to one application server and the traffic can be processed in four application servers app1 to app4 in total, which means that one application server is saved in compared to the conventional example.

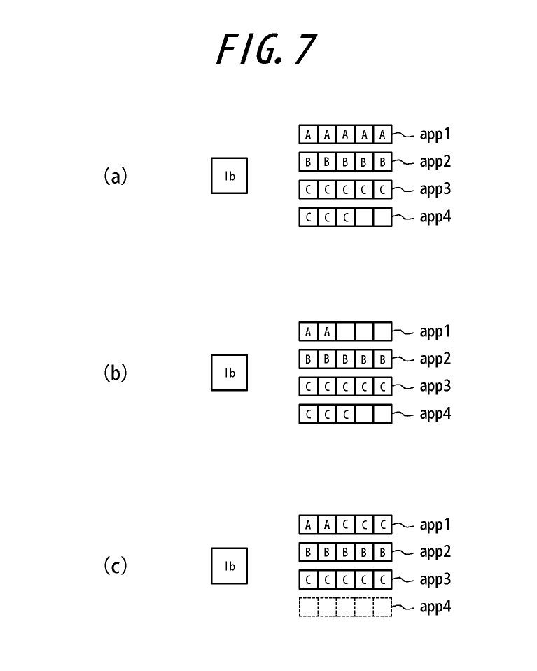

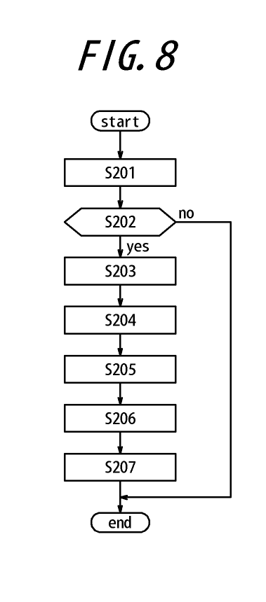

With reference to FIG. 7 and FIG. 8, processes of the main server when access is decreased in the shared scaling server system according to the first embodiment of the present invention will be described.

FIG. 7 shows one aspect that a firm of one application server is reallocated to available resources of another application server, in which a firm comprising a site exists, to which access is decreased and FIG. 8 is a flow chart showing processes of the main server.

In the example of FIG. 7 the application server app1 is the first application server, in which a firm comprising a site exists, to which access is decreased and the application server app4 is the second application server which has the smallest number of occupied resources.

When access to the site A of the application server app1 is decreased from a state of FIG. 7(a), the firm A comprising the site A is released from the resource of the application server app1 as shown in FIG. 7(b).

Then, the firm C allocated to the resource of the application server app4 is reallocated (moved) to available resources of the application server app1 as shown in FIG. 7(c).

The application server app4 is stopped since the application server app4 has only available resources.

A flow of the above-mentioned processes will be described with reference to FIG. 8.

In step S201 the monitor mm of the main server main monitors load status of the processor ap of each of the application servers app1 to app4.

In step S202 if load status of any processor ap of the application servers app1 to app4 becomes less than a threshold (yes), in step S203 the monitor mm detects a site, in which access to the resource of the application server is decreased, in which load status becomes less than the threshold. In this example the monitor mm detects site A, in which access to the resource of the application server app1 is decreased.

In step S204 the monitor mm checks whether the application servers app1 to app4 have an available resource. In this example the monitor mm checks that the application server app1 has 3 blocks of available resources and that the number of the occupied resources of the application server app4, which has the smallest number of occupied resources among the application servers app1 to app4 is 3 blocks.

In step S205 the controller mc performs reallocation of a firm and stops an application server which has only available resource. In this example since the number of available resources of the application server app1 is not less than the number of occupied resources of the application server app4, the controller mc reallocates firm C allocated to the resource of the application server app4 to the available resources of the application server app1. Afterward, since the application server app4 has only available resource (in other words, the number of occupied resources of the application server app4 becomes zero), the controller mc stops the application server app4. It is noted that the controller mc finishes the process when the number of available resources of the application server app1 is less than the number of occupied resources of the application server app4.

In step S206 the controller mc updates management information of the application servers app1 to app4.

In step S207 the controller mc releases the application server app4 from the distribution object.

It is noted that the controller mc finishes the process when load status of the processor ap of all application servers app1 to app4 is not less than the threshold in step S202 (no).

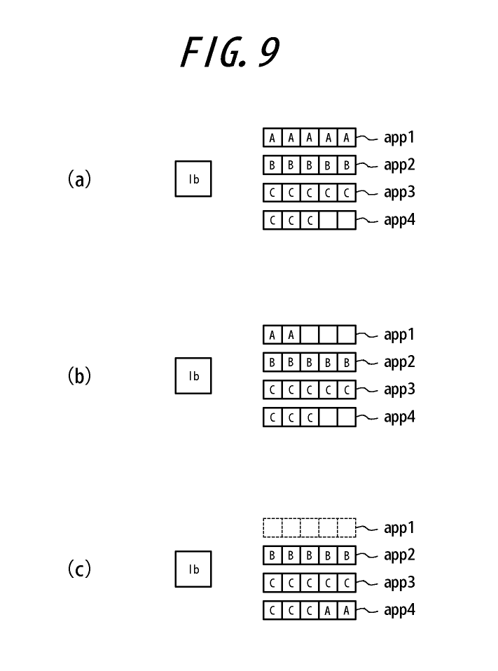

There are various aspects that a firm is reallocated to the resource when access is decreased (one aspect is step S205 of FIG. 8) and several aspects will be described with reference to FIG. 9 to FIG. 11. It is noted that an aspect that a firm is reallocated to a resource can be flexibly set by the controller mc.

FIG. 9 shows one aspect that a firm comprising a site of one application server, in which access is decreased, is reallocated to a resource of another application server. In the example of FIG. 9 the application server app1 is the first application server, in which a firm comprising a site exists, to which access is decreased.

When access to the site A of the application server app1 is decreased from a state of FIG. 9(a), the firm A comprising the site A is released from the resource of the application server app1 as shown in FIG. 9(b). Then, the firm A allocated to the resource of the application server app1 is reallocated to available resources of the application server app4 as shown in FIG. 9(c). The application server app1 is stopped since the application server app1 has only available resources.

In this example since, in step S205 of FIG. 8, the number of occupied resources of the application server app1 is not more than the number of available resources of the application server app4, the controller mc reallocates the firm A allocated to the resource of the application server app1 to the available resources of the application server app4. The controller mc stops the application server app1 since the application server app1 has only available resources.

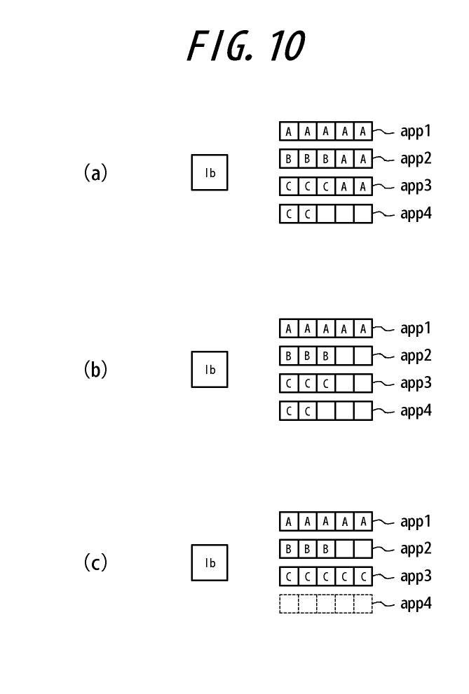

FIG. 10 shows one aspect that a firm is reallocated in view of firm gathering when access is decreased. In the example of FIG. 10 the application servers app1 and app2 are the first application server, in which a firm comprising the site exists, to which access is decreased and the application server app4 is the second application server which has the smallest number of occupied resources.

When access to the site A is decreased from a state of FIG. 10(a), the firm A comprising the site A is released from the resources of the application servers app2 and app3 as shown in FIG. 10(b). Then, the firm C allocated to the resource of the application server app4 is reallocated to available resources of the application server app3 as shown in FIG. 10(c). The application server app4 is stopped since the application server app4 has only available resources.

In this case, the firm A is allocated to the resource of the application server app1, the firm B is allocated to the resource of the application server app2 and the firm C is allocated to the resource of the application server app3. As described above, each firm is gathered and allocated to the application servers app1 to app3.

In this example, in step S204 of FIG. 8 the monitor mm checks that each of the application servers app2 and app3 has 2 blocks of available resources and that the number of occupied resources of the application server app4 is 2 blocks, which has the smallest number of occupied resources among the application servers app1 to app4.

In step S205 of FIG. 8 since the number of available resources of the application servers app2 and app3 is not less than the number of occupied resources of the application server app4, the controller mc reallocates firm C allocated to the resource of the application server app4 to available resources of the application server app3 based on the management information. Although the number of available resources of the application server app2 is 2 blocks, which is equal to the number of available resources of the application server app3, since firm B has been allocated to the application server app2 while firm C has been allocated to the application server app3, firm C is gathered in the single application server app3 by reallocating firm C to the available resources of the application server app3. The controller mc stops the application server app4 since the application server app4 has only available resources.

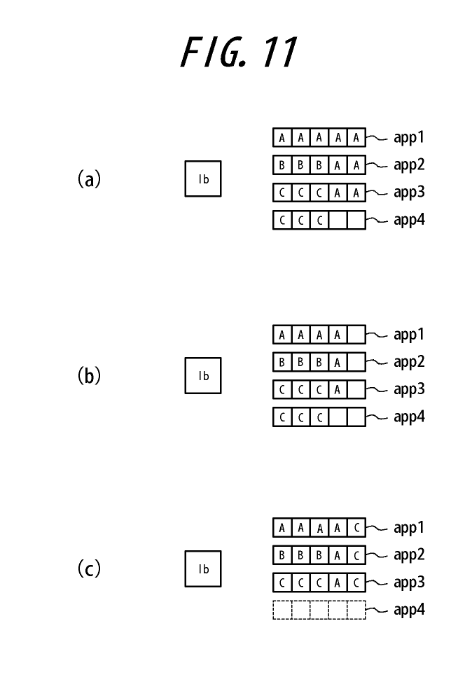

FIG. 11 shows one aspect that firms are uniformly released from resources of the application servers app1 to app3. In the example of FIG. 11 the application servers app1, app2 and app3 are the first application server, in which a firm comprising the site exists, to which access is decreased and the application server app4 is the second application server which has the smallest number of occupied resources.

When access to the site A is decreased from a state of FIG. 11(a), the firm A comprising the site A is released uniformly from resources of the application servers app1 to app3 by 1 block as shown in FIG. 11(b). Then, the firm C allocated to the resource of the application server app4 is reallocated to available resources of the application servers app1 to app3 as shown in FIG. 11(c). The application server app4 is stopped since the application server app4 has only available resources.

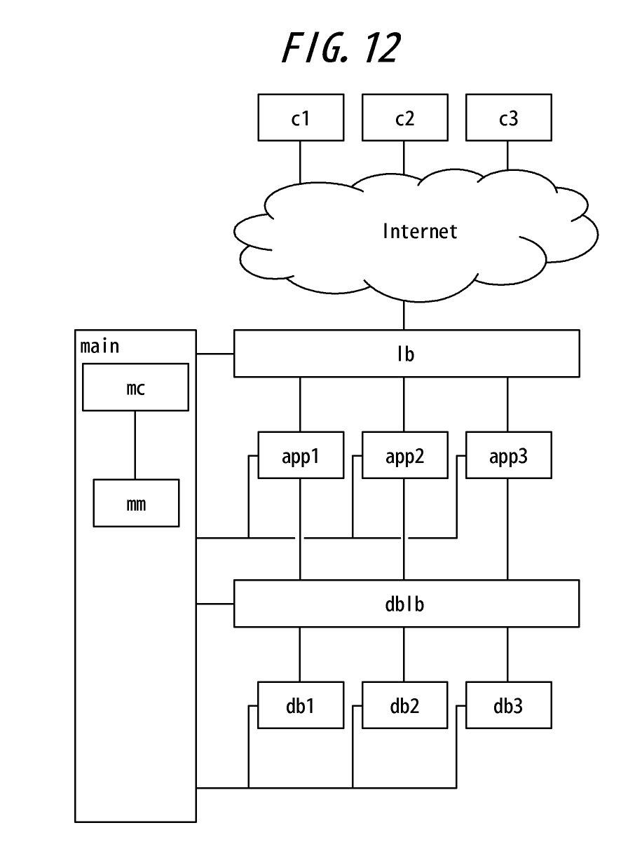

FIG. 12 is a block diagram of a shared scaling server system according to the second embodiment of the present invention. In the second embodiment the same component as those in the first embodiment is denoted by the same reference numeral and its explanation will be omitted.

The shared scaling server system according to the second embodiment of the present invention comprises a plurality of client terminals c1 to c3, an application load balancer lb, a plurality of application servers app1 to app3, a main server main, a database load balancer dblb and a plurality of database servers db1 to db3. In the shared scaling server system according to the second embodiment the database servers db is set scalable like the application servers app. It is noted that, although three database servers db1 to db3 are shown in the second embodiment, two or more database servers may be used.

The database load balancer dblb is connected to the plurality of application servers app1 to app3 and the plurality of database servers db1 to db3. The database load balancer dblb has a general load balancing function to distribute data processed by the application servers app1 to app3 based on a request from the client terminal c1 to c3 to any of the database servers db1 to db3.

The database servers db1 to db3 stores data transmitted by the application servers app1 to app3. The database servers db1 to db3 are set scalable and preferably exit on cloud computing.

The monitor mm of the main server main monitors load status (CPU utilization) and availability (free space of a storage device such as a hard disk or a memory) of resources of the database servers db1 to db3 as well as load status (CPU utilization) and availability of resources of the application servers app1 to app3. The monitor mm transmits information about load status and availability of resources of the database servers db1 to db3 in addition to information about load status and availability of resources of the application servers app1 to app3 to the controller mc.

The controller mc of the main server main controls start and stop of the database servers as well as start and stop of the application servers. Specifically, the controller mc activates a new database server db4 (not shown) depending on the information from the monitor mm and transmits instructions to the database load balancer dblb in order to set the database server db4 to a distribution object. In addition, the controller mc stops any of the existing database servers db1 to db3 depending on the information from the monitor mm and transmits instructions to the database load balancer dblb in order to release the stopped database server from the distribution object. In addition, the controller mc integrally controls operation of all portions of the main server main.

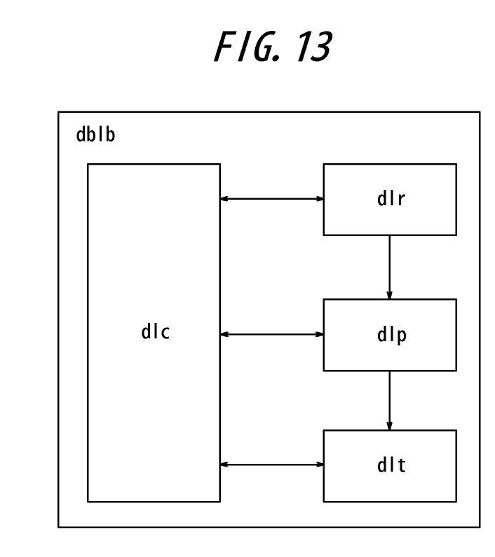

With reference to FIG. 13, the database load balancer dblb will be described in more detail.

The database load balancer dblb includes a receiver dlr, a controller dlc, a load balancing processor dlp and a transmitter dlt.

The receiver dlr receives a packet transmitted through a network.

The controller dlc transmits information of a database server of a distribution object to the load balancing processor dlp depending on information from the main server main. For example, the controller dlc transmits information that three database servers db1 to db3 are distribution objects to the load balancing processor dlp.

In addition, the controller dlc integrally controls operation of all portions of the database load balancer dblb.

The load balancing processor dlp can employ well-known load balancing processing to perform load balancing processing. The load balancing processor dlp receives a packet through the receiver dlr and selects the most suitable database server according to well-known load distribution algorithm pre-set in the load balancing processor dlp based on information from the controller dlc.

The transmitter dlt transmits a packet to the database servers db1 to db3 based on the selection of the load balancing processor dlp.

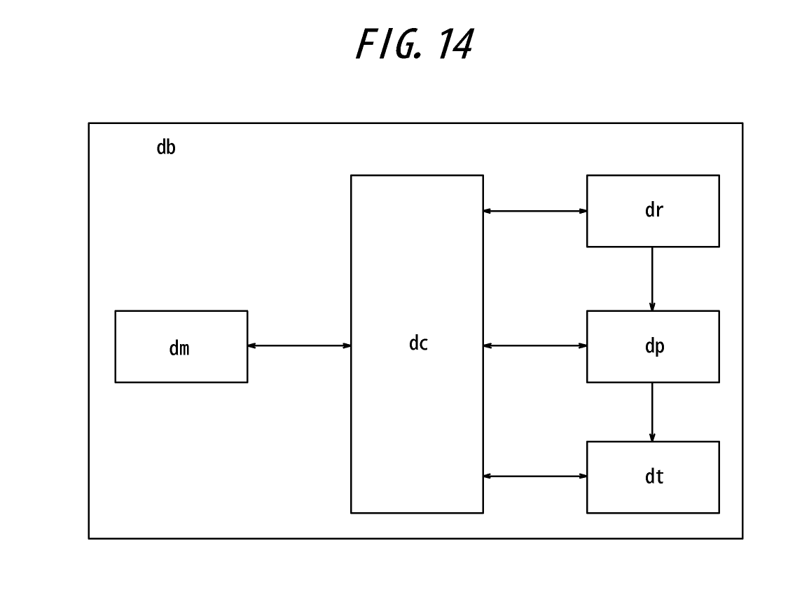

With reference to FIG. 14, the database server db will be described in more detail.

The database server db includes a receiver dr, a memory dm, a processor dp, a controller dc and a transmitter dt.

The receiver dr receives a packet transmitted by the transmitter It of the database load balancer dblb.

The processor dp performs processing depending on data transmitted by the application servers app1 to app3. The processor dp comprises a CPU, for example.

The memory dm stores data transmitted by the application servers app1 to app3. The memory dm comprises a semiconductor memory or a magnetic storage medium, for example.

The controller dc transmits information about load status of the processor dp and information about free space of the memory dm to the main server main. In addition, the controller dc integrally controls operation of all portions of the database server db.

The transmitter dt transmits a packet to the receiver lr of the database load balancer dblb.

It should be understood that the present invention is not limited to the above-mentioned embodiments but various modifications are possible.

In the first embodiment a case where the new application server app4 is activated after there is no available resource in the application servers app1 to app3 is described. However, it is possible to activate the new application server app4 when available resource of the application servers app1 to app3 becomes, for example, less than 10% of the total amount.

In addition, a plurality of application load balancers and a plurality of database load balancers may be used. Furthermore, the database server may employ a master/slave configuration and a slave database server may be set scalable.

What is claimed is:

1. A shared scaling server system comprising:
a plurality of client terminals for transmitting a request;
an application load balancer for distributing the request transmitted by the plurality of client terminals;
a plurality of application servers for processing the request distributed by the application load balancer;
a main server connected to the application load balancer and the plurality of application servers and having a monitor and a controller;
wherein
the monitor monitors load status of the plurality of application servers;
the monitor detects a site, in which access to a resource of at least one application server is increased when the monitor judges that load status of the at least one application server exceeds a threshold;
the monitor checks availability of a resource of the plurality of application servers;
the monitor transmits information about the availability of the resource of the plurality of application servers to the controller;
the controller, depending on the information, processes traffic of the site, in which access is increased, in an available resource of the plurality of application servers; and
the controller, depending on the information, activates a new application server when there is no available resource in the plurality of application servers, allocates a firm comprising the site, in which access is increased, to an available resource of the new application server and processes traffic of the site, in which access is increased, in an available resource of the new application server.

2. The shared scaling server system according to claim 1, wherein
the monitor monitors load status of the plurality of application servers;
the monitor detects a site, in which access to a resource of at least one application server (a first application server) is decreased when the monitor judges that load status of the first application server is less than a threshold;
the monitor checks availability of a resource of the plurality of application servers; and
the monitor transmits information about the availability of the resource of the plurality of application servers to the controller; and
the controller, depending on the information, reallocates a firm allocated to a resource of an application server (a second application server) which has the smallest number of occupied resources, to an available resource of an application server except the second application server and stops the second application server when the number of occupied resources of the second application server becomes 0, or
the controller, depending on the information, reallocates a firm allocated to a resource of the first application server to an available resource of an application server except the first application server and stops the first application server when the number of occupied resources of the first application server becomes 0.

3. The shared scaling server system according to claim 1 or 2 further comprising
a database load balancer for distributing data transmitted by the plurality of application servers and
a plurality of database servers for storing the data distributed by the database load balancer,
wherein
the database load balancer and the plurality of database servers are connected to the main server;
the monitor monitors load status of the plurality of database servers;
the monitor detects a site, in which access to a resource of at least one database server is increased when the monitor judges that load status of the at least one database server exceeds a threshold;
the monitor checks availability of a resource of the plurality of database servers;
the monitor transmits information about the availability of the resource of the plurality of database servers to the controller;
the controller, depending on the information, processes traffic of the site, in which access is increased, in an available resource of the plurality of database servers; and
the controller, depending on the information, activates a new database server when there is no available resource in the plurality of database servers, allocates a firm comprising the site, in which access is increased, to an available resource of the new database server and processes traffic of the site, in which access is increased, in an available resource of the new database server.

4. The shared scaling server system according to claim 3, wherein
the monitor monitors load status of the plurality of database servers;
the monitor detects a site, in which access to a resource of at least one database server (a first database server) is decreased when the monitor judges that load status of the first database server is less than a threshold;
the monitor checks availability of a resource of the plurality of database servers; and
the monitor transmits information about the availability of the resource of the plurality of database servers to the controller; and
the controller, depending on the information, reallocates a firm allocated to a resource of an database server (a second database server) which has the smallest number of occupied resources, to an available resource of an database server except the second database server and stops the second database server when the number of occupied resources of the second database server becomes 0, or
the controller, depending on the information, reallocates a firm allocated to a resource of the first database server to an available resource of an database server except the first database server and stops the first database server when the number of occupied resources of the first database server becomes 0.
